(19) United States
(12) Patent Application Publication
(10) Pub. No.: US 2009/0142137 A1
(43) Pub. Date: Jun. 4, 2009

(54) ASSESSMENT AND REMEDIATION PROCESS FOR CONTAMINATED SITES

(75) Inventors: Tanya Lynn MICHAILUCK, Calgary (CA); Bonita Susan SWIFT, Calgary (CA)

Correspondence Address: DAVIS & BUJOLD, P.L.L.C., 112 PLEASANT STREET, CONCORD, NH, 03301, US

(73) Assignee: PIONEER PROFESSIONAL SERVICES GROUP LTD., Calgary (CA)

(21) Appl. No.: 12/324,116

(22) Filed: Nov. 26, 2008

Related U.S. Application Data
(60) Provisional application No. 60/990,212, filed on Nov. 26, 2007.

(51) Int. Cl. B09C 1/00

(52) U.S. Cl. 405/128.7

(57) ABSTRACT

Process for assessing and remediation of a contaminated site comprising the steps of assessing the contaminated soil and/or groundwater at a contaminated site involving geophysical scans of the contaminated site and pH, microbial, salinity and metal testing of the soil and/or water contained in the site or other site specific parameters. Remediation of the soil and/or water at the site insitu is followed involving electro-kinetics of the contaminated site. Water testing is carried out during remediation to determine the effect of remediation. Following remediation, an assessment of the remediated soil and water involves electromagnetic scans of the contaminated site as well as pH, microbial, salinity and metal testing of the soil and water contained in the site Once the results of all tests are analysed, the electro-kinetic remediation can be deemed successful or optimized and continued for an extended duration. Effluent water collected from electrodes during remediation can be treated using electrodialysis or suitable technology and then used to flush the vadose zone or reinjected into the groundwater zone the water was extracted from.

### FIELD OF THE INVENTION

This invention relates generally to assessment and remediation processes of contaminated sites.

### BACKGROUND OF THE INVENTION

Remediation deals with the removal of pollution or contaminants from environmental media such as soil, groundwater, sediment, or surface water for the general protection of human health and the environment, or in some cases the clean-up of a Brownfield site (abandoned, idled, or under-used contaminated location) for the purpose of redevelopment, Remediation is generally subject to an array of regulatory requirements, and can be based on assessments of human health and ecological risks where no legislated standards exist or where standards are advisory. Procedures, methodologies, and protocols must be developed, in order to properly remediate sites.

Remediation methodologies are many and varied but can be categorised into ex-situ and in-situ methods. Ex-situ methods involve excavation of impacted soils and subsequent treatment at the surface. These traditional processes are disadvantageous as they consist primarily of soil excavation and disposal to a landfill. This approach is often referred to as “dig and dump” and in the case of groundwater “pump and treat”, As the cost of the “dig and dump” approach increases and available landfill space is becoming limited, this approach is less favoured. As a result, industry is looking for more innovative and cost effective ways to deal with their remediation liabilities.

In-situ methods of remediation seek to treat the contamination without removing the soils. Some of the current methods, to name a few, consist of techniques such as: in-situ oxidation, bioremediation, volatilization, thermal techniques, soil vapour extraction, and soil washing. In addition, to the technology around these applications, many environmental firms have also developed their own individual processes and methodologies to apply these applications based on specific, soil contaminant and groundwater conditions.

Salt contamination from upstream oil/gas activities and road salting processes are a major concern through out North America. One of the major reasons for this is that salts behave like a plant sterilant in soils. When salinity concentrations in soils exceed the levels acceptable to plants, the roots of plants through the process of osmosis take up water. Osmosis involves the movement of water from regions of low salinity concentration (such as the soil) to regions of high salinity concentration (such as the inside of plant root cells). When salinity concentrations in the soil are too high, the movement of water from the soil to the root is slowed down. When the salinity concentrations in the soil are higher than inside the root cells, the soil will draw water from the root, and the plant will wilt and die. This is the basic way in which salinization affects plant production.

The damaging effects of salinity on plants are caused not only by osmotic forces, but also by toxic levels of sodium and chloride. From a commercial crop perspective, salts can cause significant financial damage to agricultural operations A salinity remediation process, especially one that can work in clay conditions is needed. Current remediation processes are disadvantageous as salts are very difficult to remove from tightly consolidated soils.

One way to accomplish salt removal from tightly consolidated soil is through electro-kinetic remediation. Electro-kinetic remediation is accomplished by placing electrodes in salinity contaminated soil and/or groundwater and applying direct current across electrodes. The basic process of electro-kinetics includes: imposing an electrical field on the volume of contaminated soils; migrate charged ions and cations under the influence of an electric field; migrate anions and cations to the respective opposite electrodes; flushing the vadose zone (unsaturated soils in the subsurface) with clean water and extracting contaminated groundwater (effluent) downgradient of the remediation area or within the remediation area for potential disposal or exsitu treatment (above ground treatment of effluent water). Effluent water can be treated utilizing a variety of techniques including electrodialysis. However, current processes require removal of water from the site for ex situ disposal or treatment. The electrodialysis equipment is portable and can be hauled to the site for onsite treatment. There is currently no process that combines both treating the water at the contaminated site with electrodialysis (for recycling in the electro-kinetic remediation process or for deep well injection) and electro-kinetic remediation.

While electro-kinetic remediation has been proven, to a limited degree, to be an effective technique in removing salts from saline contaminated soils and groundwater, no process is available for determining the impacts of this technology on various parameters in the soil and/or groundwater. As such, there is no process available to test the effect of the remediation on the overall soil and water quality, or for optimizing further electro-kinetic remediation. Further, there is no process that combines electro-kinetic remediation of soil with electrodialysis of water in a contaminated site.

### SUMMARY OF THE INVENTION

This invention relates to a process comprising a combination of steps of assessment and remediation of contaminated sites and more specifically to the assessment and remediation of soil and/or water (groundwater and effluent water) contained at a contaminated site. According to one aspect of the invention, the process for assessing and remediating a contaminated site comprises the steps of:
assessing contaminated soil and/or groundwater at a contaminated site by conducting geophysical scans of the site;
assessing the contaminated soil and/or groundwater by analyzing the soil and water samples for chemical parameters;
remediating the soil and/or groundwater by electro-kinetics;
during remediation, assessing the contaminated site by conducting hydrogeological and chemical tests of the water; and
assessing the remediated site by conducting geophysical scans of the site.

Further, the process for assessing and remediating a contaminated site can comprise the steps of assessing contaminated soil and water by conducting chemical tests (which may include but are not limited to salinity, metal, and pH parameters), and microbial tests of the soil may be carried out before remediation. The contaminated site is typically contaminated with elevated salinity parameters but can be contaminated with a variety of contaminants.

The process for assessing and remediating a contaminated site can further comprise the step of electrodialysis of water during electro-kinetic remediation of the soil and/or groundwater in the contaminated site. The water can be remediated alone by electrodialysis or a similar process and reused in the remediation process or reinjected into the groundwater zone the water was previously extracted from. By utilizing electrodialysis for the effluent water on site, this enables the effluent water to be treated and reused in the treatment process or injected back into the groundwater zone where the waters were extracted from. By utilizing the treated waters in the remediation process, rather than hauling in fresh water from an offsite location, the remediation process described in this document becomes more sustainable as less waste is moved to a different location i.e. land fills or deeper within the earth (deep well injection). Following remediation, the process for assessing and remediating a contaminated site can further comprise the steps of conducting chemical tests (which may include but are not limited to pH, salinity and metal parameters) of the soil and water and microbial tests of the soil. The results of these tests can be compared to results from tests carried out prior to the electro-kinetic remediation to determine the success of the remediation and to optimize further remediation if necessary.

This process can be used in areas with contamination below the ground surface. An assessment prior to remediation is a necessary step of the process to determine the pH, salinity, microbial, metal and of the chemical composition of the contaminated site. Geophysical scans including EM/ERT provide a visual image of the bulk conductivity at and below the ground surface. Remediation steps can follow in an attempt to remediate the contaminated soil and water.

The process for assessing and remediating a contaminated site can comprise the steps of assessment following remediation to determine the effect of the remediation on the contaminated site including the success of the remediation as well as any negative effect the remediation has had on the pH, microbial, salinity and metal parameters of the soil and water contained in the site. Further remediation if necessary can be optimized based on these results. Further, the process for assessing and remediating a contaminated site can comprise the steps of assessment during remediation to establish the progress of the remediation. Ideally the assessment(s) during the remediation process are conducted to track the changes in soil and/or groundwater chemistry. If no groundwater is present within the remediation zone, a soil assessment can occur during remediation to establish if soil chemistry is changing due to the remedial processes. The results of all tests conducted prior to remediation establish a baseline for comparison with results from all tests conducted after remediation. This is an advantage over the prior art because the process of combining soil and water assessments before, during, and after soil electro-kinetic remediation, can determine the effect of the electro-kinetic remediation on the soil and water. This allows for further optimized remediation to be conducted. Additionally, by combining electrodialysis with this process, water is able to be treated and recycled.

### BRIEF DESCRIPTION OF THE DRAWINGS

FIG. 1. is a flow chart of the process for assessing and remediating contaminated soil and water representative of one of the embodiments of the present invention.

FIG. 2, is a schematic diagram of the electro-kinetic process illustrating anion and cation migration in soil.

FIG. 3. is a block diagram of the electrodialysis process which is one of the possible effluent water treatment options in the present embodiment.

FIG. 4. is a graph showing there is no effect to groundwater levels due to the operation of the Electrokinetics system Background groundwater levels had similar (lowest trend line) trends as groundwater levels within the rememdiatio area (upper trend line).

FIG. 5. is a graph showing ground water pH is not affected by electro-kinetic remediation.

FIG. 6A is a graph showing increased levels of Arsenic in groundwater as a result of electro-kinetic remediation.

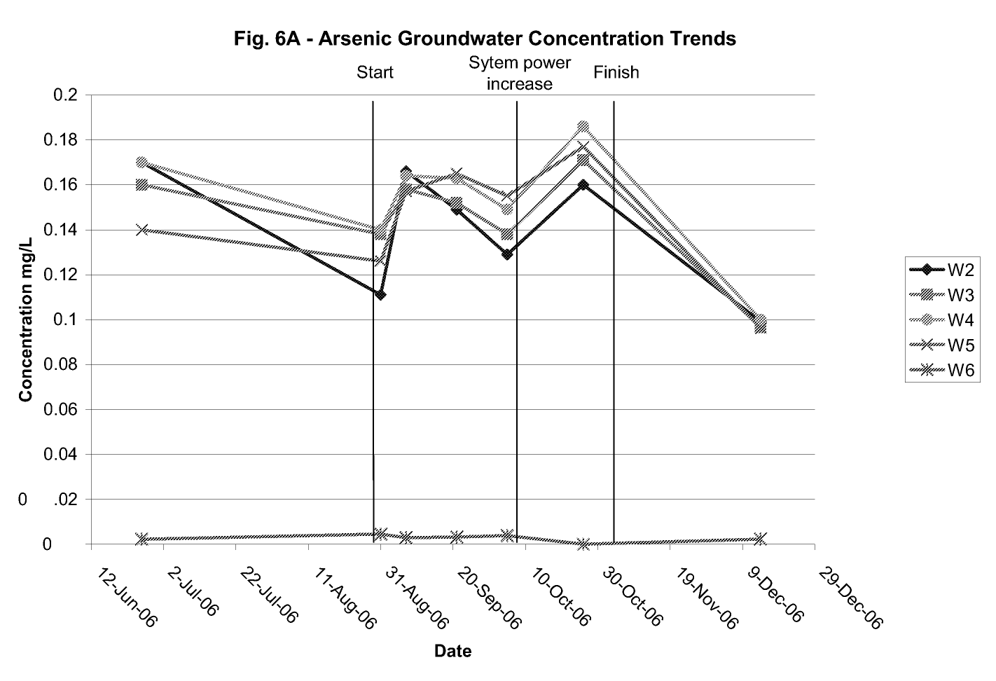

FIG. 6B. is a graph showing decreased levels of Sulphur in groundwater as a result of electro-kinetic remediation.

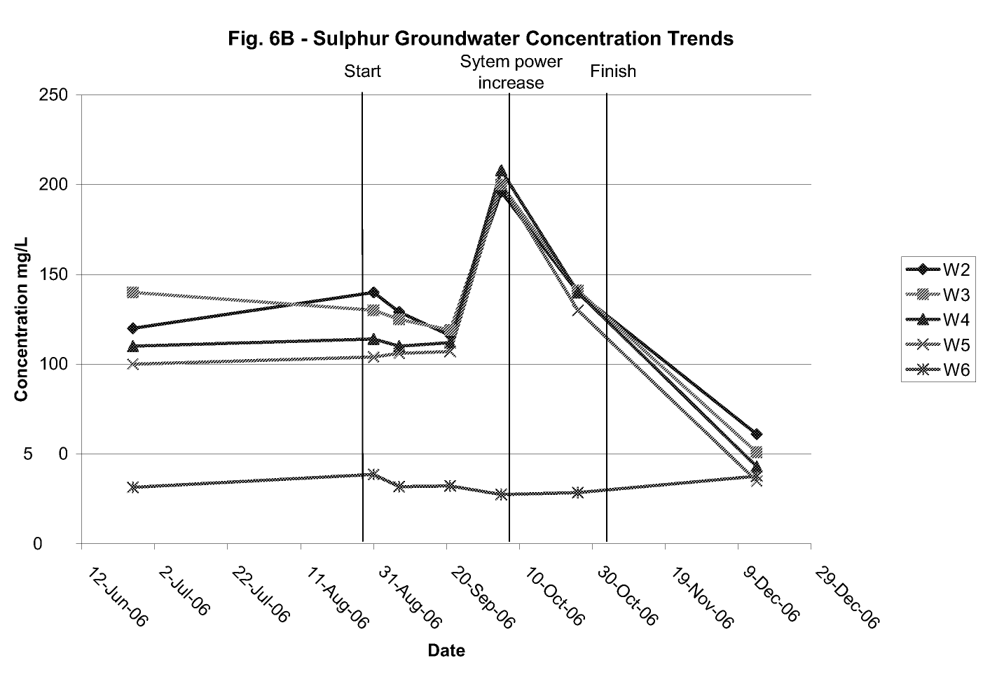

FIG. 6C. is a graph showing decreased levels of Barium in groundwater as a result of electro-kinetic remediation.

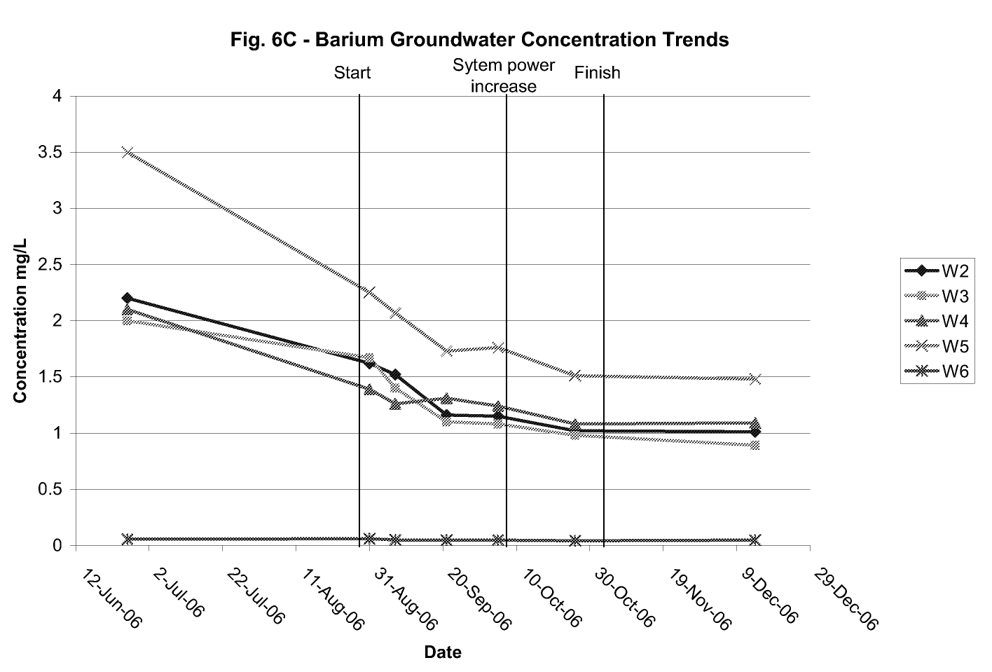

FIG. 6D is a graph showing is a graph showing decreased levels of Manganese in groundwater as a result of electro-kinetic remediation.

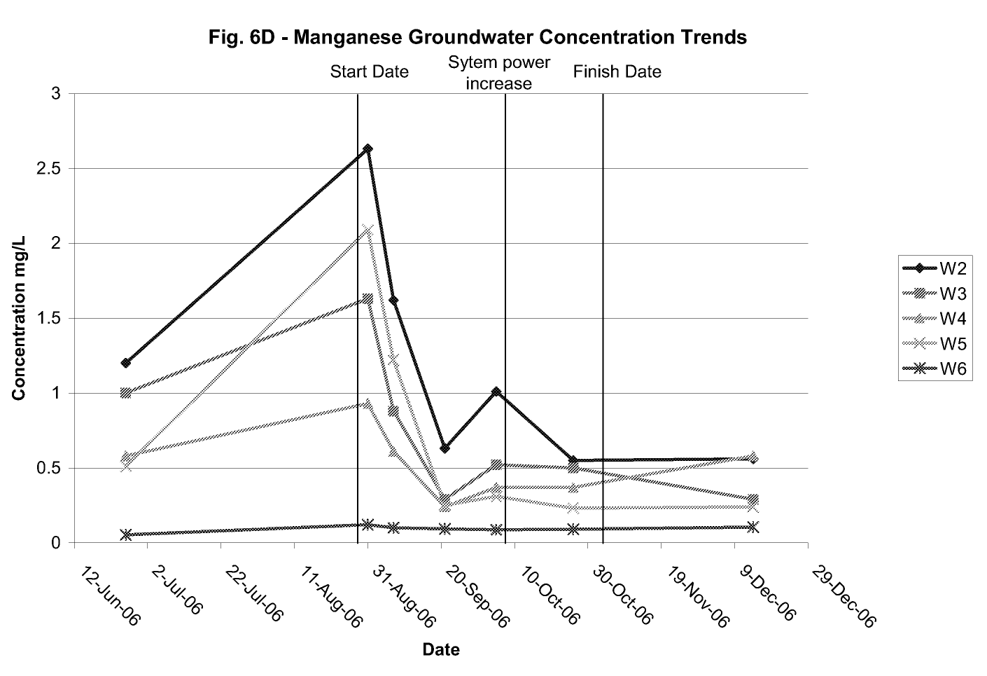

FIG. 7. is a graph showing decreasing levels of Electrical Conductivity (EC) in the groundwater during the operation of the Electrokinetics system.

FIG. 8. is a graph showing dissolution of chlorides from soils to groundwater after the Electrokinetics system started up and following an increase of the system voltage.

FIG. 9A is an EM scan of the contaminated site prior to electro-kinetic remediation.

FIG. 9B is an EM scan of the contaminated site after the electro-kinetic remediation. The post electro-kinetic remediation scan shows that the conductivity of the contaminated area has decreased in the area of the electrokinetics system was applied.

FIG. 10 is an ERT survey of the contaminated site indicating lower conductivity in the vicinity of electrodes.

### DETAILED DESCRIPTION OF THE EMBODIMENTS

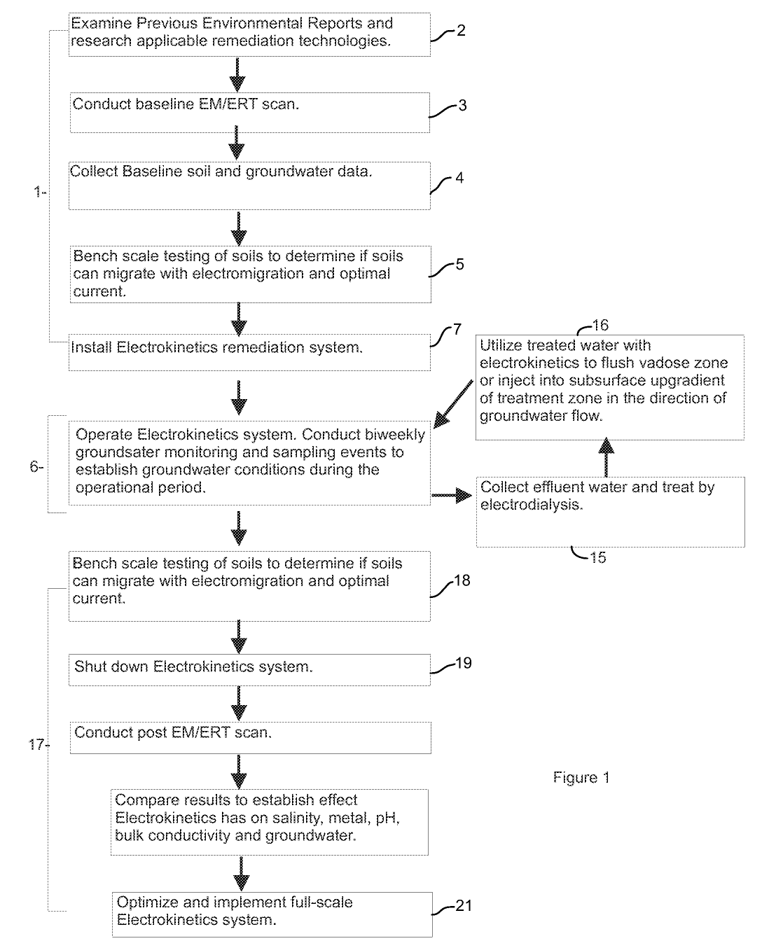

Referring to FIG. 1, and according to one embodiment of the invention, there is provided a process for assessing and remediating contaminated soil and water. The process is comprised of a combination of steps involving the assessment of a contaminated site before and after remediation and the steps of electro-kinetic remediation of the soil and may include the step of electrodialysis of the water at the contaminated site. The contaminated site is typically contaminated with elevated salinity parameters but could be contaminated with other contaminants. These steps are undertaken during the process of assessing contaminated soil and water at a contaminated site by conducting geophysical scans of the site prior to remediation, conducting soil and water assessments prior to remediation, remediating the soil and/or groundwater and assessing the water and/or soil, remediating the water, and assessing the remediated soil and water by conducting geophysical scans of the site and conducting tests of the remediated soil and water.

Further, each major portion of the process may involve multiple steps as described as follows:

### Assessing Contaminated Soil and Water at a Contaminated Site by Conducting Geophysical Scans of the Site Prior to Remediation

A first step of this process is examining environmental reports for the contaminated site and then researching applicable remediation technologies 2. The contaminated site is typically contaminated with Sodium Chloride (NaCl) but can be contaminated with a variety of contaminants. After an appropriate remediation technology is selected, geophysical scans are conducted to determine a baseline scan for the contaminated site 3. Geophysical investigation methods used may include electromagnetic (“EM”) and/or electrical resistivity tomography (ERT). Further, the EM scan may include: Electromagnetic (EM31) scanning which provides 2-D horizontal image of the bulk surface electrical conductivity from surface to approximately 6 m below the ground surface and/or Electrical Resistivity Tomography (ERT) which provides 2-D vertical image of the conductance of subsurface materials.

Electromagnetic (EM) methods utilize the principle of electromagnetic induction in assessing the ground electrical conductivity. EM instruments are generally comprised of a transmitter coil, a receiver coil, and a console. The transmitter coil operates by generating a very low frequency (VLF) magnetic field which, when passing through a conductive medium (ground), will induce an electrical current. The induced current creates secondary magnetic fields, which are sensed by the receiver coil. The magnitude and phase of these secondary fields are related to the electrical properties of the subsurface material.

Typically, EM instruments record the quadrature (Q) and the in-phase (I) components of the induced magnetic field. The Q component corresponds to the apparent terrain conductivity, which represents the bulk terrain conductivity of the soil material and pore fluids. Electrical conductivity of soils and rocks is primarily electrolytic (electrical current is transmitted via dissolved solids in the pore spaces). An increase in total dissolved solids (salt) in the soil will increase the observed electrical conductivity of the soil. Sands and sandstones, due to their relatively high content of quartz, act as electrical insulators and exhibit low electrical conductivity values. Clay and shales will generally release ions in the pore spaces with the introduction of small amounts of moisture, and thus exhibit relatively high conductivity values. Accordingly, electromagnetic surveys are an effective tool in mapping inorganic (salt) impact on soil and groundwater. The EM31 records the apparent terrain conductivity in milliseimens per meter, (mS/m).

Typically, the EM data is acquired at an average of 1 m intervals along lines spaced at approximately 5 m apart. A Geonics EM31-MK2 (EM31) is used to acquire the terrain conductivity data. The EM31 is integrated with a Global Positioning System (GPS) receiver platform that enables automatic and continuous EM and positional data collection. Automated data collection provides a rapid, cost-effective and detailed coverage of the studied site. The Quadrature EM (representing terrain conductivity) and Inphase (a metal indicator) parameters are recorded simultaneously with the EM31 at each station within the location. ERT acquisition survey is performed by transmitting an electric current through steel rods (electrodes) that are inserted into the ground. A battery is used as a power source for the required current. The electrodes are spaced at predetermined intervals and readings are collected and processed with a microprocessor. The calculations required for this step are generally known by those skilled in the art.

Other geophysical methods, other than electromagnetics (EM) and electrical resistivity tomography (ERT), can be used separately or in conjunction with other geophysical methods to characterize the site depending on the site land use history and the suspected contaminants and their concentrations on the site.

### Soil and Water Assessment Prior to Remediation

Once the geophysical assessment of the contaminated site is complete, the soil and water is assessed for pH, salinity and metal parameters and the soil is assessed for microbial parameters. The methods for these assessments are mostly known in the art. Other assessment of chemical parameters in the soils and water may be required depending on the site land use history. Based on the baseline data acquired from the EM/ERT scan, or other geophysical methods, monitoring wells and soil test locations are determined 4.

Groundwater wells are installed in the vicinity of the electrodes to monitor any changes in groundwater quality (in respect to chemical parameters) due to the operation of an electro-kinetics system (discussed later). It is preferable to install the groundwater wells at varying distances from the electrodes to determine the electrode influence on remediating the soils and groundwater and any causing changes to the soil and groundwater condition (i.e. pH, microbial populations or dissolution of metals from soil to groundwater). Routine (which include pH and salinity) parameters monitored may include, pH, Electrical Conductivity (EC), Total Dissolved Solids (TDS), Chlorine (CI), Sodium (Na), Calcium (Ca), and Magnesium (Mg). Metal parameters typically include Arsenic (As), Barium (Ba), Cadmium (Cd), Lithium (Li), Manganese (Mn), Selenium (Se), Sulfur (S), Thallium (Ti) and Vanadium (V). One or more background wells (wells placed upgradient of the direction of groundwater flow and in an area not contaminated) are also required to compare to groundwater conditions in the remediation area. One or more wells should be placed downgradient of the direction of groundwater flow and the remediation area. The correct spacing of wells must be ensured, as electrodes will be placed near them and after the wells are already installed. Wells consist of solid and slotted (screened) sections. Installation of the electrodes follows the baseline assessment to ensure the electrodes are placed within the contaminated area requiring treatment. The well screen should straddle the perceived water table (based on any historic data or indications of water presence during drilling) and include the depth of any electrodes that are placed in saturated soils. In some cases, water wells may be installed to determine concentrations of various monitored parameters at a specific location and depth, which requires screening at a specific interval, and may not necessarily straddle the water table.

Baseline groundwater monitoring and sampling is conducted at installed wells. Monitoring includes measuring water elevations and combustible vapour readings. Groundwater samples are collected from the wells following monitoring and purging of stagnant well water and screen pack volumes Samples are appropriately collected, preserved and stored prior to shipping to a laboratory for analyses of routine and dissolved metal parameters (referred to earlier).

Baseline soil sampling is conducted at well installation locations as well as other select locations. All sampling locations have recorded GPS coordinates or an equivalent means of geo-referencing their location (i.e. field surveying). Sampling locations are placed in the vicinity of the electrodes and at select distances from the electrodes.

Soil samples are collected at each sampling location at various depths below the ground surface and at the ground surface. A cohort of soil samples taken from these locations, specifically from the ground surface and depths below the ground surface that correspond with the depth of the electrodes are submitted to a laboratory for analyses of heterotrophic microbe plate counts, grain size, as well, salinity and metal parameters 4 (referred to earlier). These laboratory analyses are generally known in the art. If any other contaminants are suspected to be present based on the history of land use at the property, additional parameters, such as hydrocarbons, are tested for in the soils and/or groundwater samples. A cohort of soil samples are submitted for analysis of heterotrophic microbe plate counts to determine microbial presence and quantifications. The plate counts are be compared with soil samples collected at similar locations and depths after the Electro-kinetics remediation operation is completed. A consistent reduction or increase in plate counts for the majority of comparable samples would indicate that the Electro-kinetics system used in remediation affects the microbe population.

During the pre-remediation testing, contaminated soils are collected from the remediation area for bench scale testing 5. Samples of the excavated soils are collected prior to shipping for analytical testing of salinity parameters, heterotrophic bacteria count, metals and grain size as well as other parameters known to one skilled in the art. The bench scale tests consist of applying different voltages and amperages using a step approach to determine the rate of movement in the soil. These bench scale tests are known to one skilled in the art. The processes involved in the design are adjusted as needed to determine the best efficiency of contaminant migration. Soil samples are taken prior to bench scale initiation and then during the bench scale tests. The soil samples are tested for salinity and/or metals parameters (referred to earlier) to determine if anions and cations can migrate with electromigration and an optimal current to provide such electromigration is determined. Additionally the soils are tested for microbial activity and metal parameters. Water extracted from the electrodes is also tested for routine water (including pH and salinity parameters) and metal parameters (referred to earlier). Once the soil and water samples have been analyzed, equipment needed for the remediation step is designed utilizing these bench scale results.

### Remediation of Soil and Assessment of Groundwater

Following the assessment of the soil and water before remediation, remediation of the soil and water is carried out. This step may involve electro-kinetic remediation of the soil 6 and may also involve electrodialysis of the water 15 or other suitable treatment of the water. In some situations, remediation of the water may not be carried out.

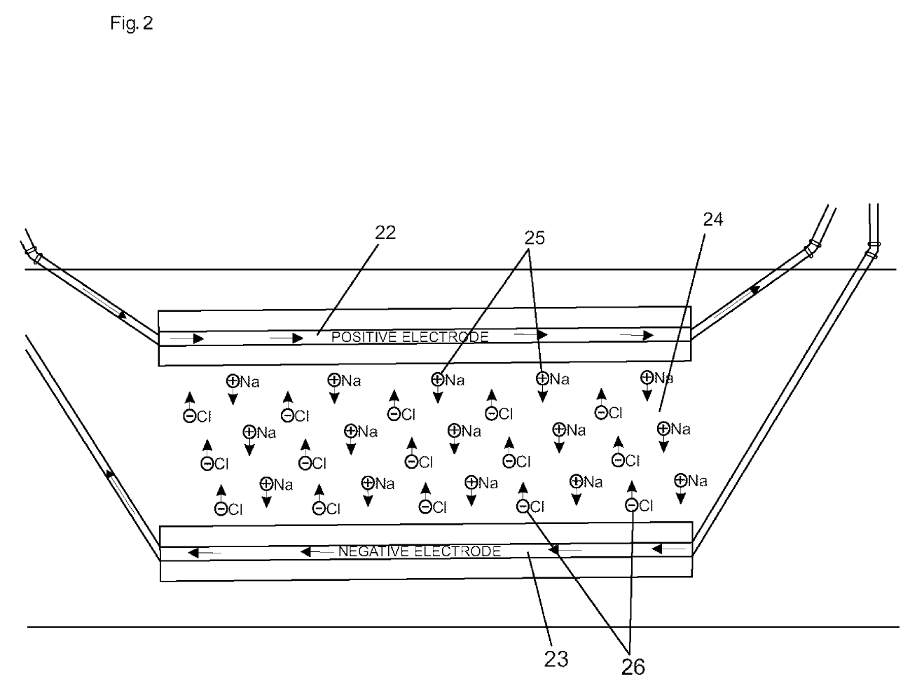

Further and more specifically, an electro-kinetic remediation system is installed 7 and operated until an accepted level of remediation is achieved using the optimized current. Electro-kinetic techniques necessary for this step are known in the prior art. Referring to FIG. 2, generally electro-kinetic remediation involves placing electrodes (an anode 22 and a cathode 23) in salinity contaminated soil 24 and/or groundwater and applying direct current across electrodes. The basic process of electro-kinetics includes: imposing an electrical field on the volume of contaminated soils; migrate charged anions 25 and cations 26 under the influence of an electric field; migrate anions 25 and cations 26 to the respective opposite electrodes; flushing the vadose zone (unsaturated soils in the subsurface) with clean water and extracting contaminated groundwater (effluent) downgradient or within the treated area for potential disposal or exsitu treatment (above ground treatment of effluent water).

Groundwater sampling is conducted during the electro-kinetic remediation and tested for metal and routine parameters (including pH and salinity), The length of the electro-kinetic remediation can be more or less than 2 months, depending on the results of the groundwater samples. If salinity parameters have not migrated under the influence of the electrokinetics system the remediation may need to be run longer to produce necessary changes in salinity concentrations in groundwater samples. Further, if groundwater testing results in changes to the parameters tested, the remediation may be stopped sooner. The groundwater testing results are examined for but not limited to changes in pH values and concentrations of dissolved metals and salinity parameters (referred to earlier). Ideally, a reduction in salinity parameters, negligible changes in pH and dissolved metals would occur when comparing baseline assessment results to post assessment results (following remediation). 6. Bi-weekly monitoring and sampling of groundwater is conducted once the electro-kinetic remediation system is operational during the remediation. Groundwater monitoring includes but is not limited to measuring groundwater elevations. More or less frequent monitoring and sampling of the groundwater may be required based on site-specific conditions. If groundwater is not present in the area being remediated, soils can be tested at regular intervals to establish if the Electrokinetics system is effectively remediating the elevated salinity in the remediation area during the operation of the system

### Remediation of Water

For the remediation of water in this process, water can include groundwater, water removed by the electro-kinetic system from the soil, water that has been added to the entire process and removed during the process, or any other water in the immediate area. Effluent water from the process is collected and treated by electro-dialysis onsite or offsite depending on the availability of an electodialysis system 15. Electrodialysis or an other suitable treatment system is used to treat effluent water that is extracted from the electrodes of the Electro-kinetics system. However, remediation of water may not be a necessary step in the process in all situations (where little or no effluent water is collected for example).

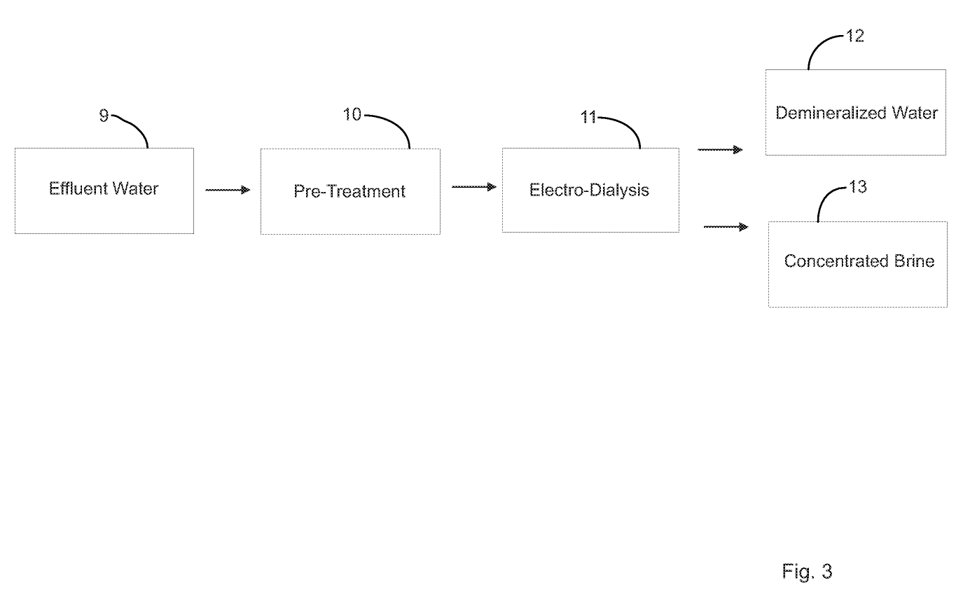

Referring to FIGS. 1 and 3, electrodialysis is a method of removing dissolved salts from saline waters 9. The method of electrodialysis is generally known in the art and can be summarized as follows: Electrodialysis applies a direct current to transport dissolved ions in an aqueous solution through a membrane under the influence of an electrical potential gradient. The Electrodialysis method includes a direct current from a three phase power source applied; saline water goes through pre-treatment 10 to remove particulates and total suspended solids; and pre-treated water flows through an electrodialysis stack 11 were desalination takes place. The method produces highly concentrated brine 13 and water with much lower concentration of ions (TDS) 12. The water with a lower concentration of ions can be recycled 14. Where the water has sufficient water hardness or hydrocarbon contamination 15, the water may need pre-treatment prior to electrodialysis. Pre-treatment may include reducing the total water hardness, or removal of particulate matter (i.e. soil particles). Alternatively the effluent water can be treated by a technology other than electrodialysis. Once water has been treated it can be injected into the subsurface upgradient of the treatment zone in the direction of groundwater flow 16. If water can be treated during system operation, the treated water can be utilized in the remediation process. At the end of soil and groundwater remediation, if water cannot be reinjected back in to the ground it can also be hauled offsite for appropriate disposal. The saline effluent water can be deep well injected after it is collected from the electrodes during the electrokinetics remediation process. By combining the step of electrodialysis or equivalent salinity treatment technology with the elector-kinetic remediation, this enables the effluent waters to be treated and reused in the treatment process or injected back into the groundwater zone where the waters were extracted from. By utilizing the treated waters in the remediation process, rather than hauling in fresh water from an offsite location, the remediation process described in this document becomes more sustainable as less waste is moved to a different location i.e. land fills or deeper within the earth (deep well injection).

### Assessing the Remediated Soil and Water by Conducting Geophysical Scans of the Site, Conducting Tests of the Soil and Water, and Conducting Microbial Tests of the Soil

Following the remediation, in another step of the process 17 an assessment is carried out on soil and water. More specifically, following the operation of the electro-kinetic system, the electro-kinetic system is shut down 18 and a post geophysical scans are conducted 19. These may be EM/ERT scans. Groundwater and soil samples are also sampled at this time at the same depths and locations as conducted prior to remediation and submitted for the same laboratory analyses and compared to pre-remediation results. The post-remediation geophysical scan (EM/ERT scan) and assessment results are then compared with the pre-remediation geophysical scan (EM/ERT scan) and assessment results to establish the effect of the electro-kinetic system on the bulk conductivity, pH, salinity, metal and microbial parameters in the soils and groundwater 20. Once the effect has been determined another step including continued remediation using the electro-kinetic system can be optimized and implemented for a longer time period 21. This time period may extend from the time post-remediation tests are conducted to the time when additional tests are carried out and the remediation is deemed to be successful or partially complete. The last step is to determine the extent of the remediation by conducting chemical analyses on the soil and water (referred to earlier). All data from tests conducted following electro-kinetic remediation is compared with data from tests conducted prior to electro-kinetic remediation. The electro-kinetic remediation can then be stopped if deemed successful. The extent to which remediation is deemed successful may be determined by a regulatory body or by a pre-set standard. Alternatively, The results of the tests could indicate that further electro-kinetic remediation is required in which case, the electro-kinetic remediation could then be optimized to the specific situation of the particular contaminated site.

This invention can be illustrated further by the following example, which is not to be construed as limiting in scope.

### EXAMPLE

### Research and Initiation

Preliminary research on electro-kinetic remediation and impacts on soil was carried out,

A contaminated site was selected for study. Previous environmental reports written on the selected site were reviewed.

### Pre-EM/ERT Scan

Baseline EM/ERT scans were conducted prior to conducting the remediation.

### Baseline Soil Assessment and Groundwater Well Installations

### Base-Line Soil Sampling:

Utility locates were performed prior to conducting any ground disturbance.

Soil samples were collected at well installation points and at other sampling locations which did not have wells installed within them. A total of 12 boreholes were advanced, 5 of which had monitoring wells installed within them, Boreholes were advanced either 0.5 (3 sampling locations), 0.8 (2 sampling locations), 1.8 (3 sampling locations), 2.8 or 6.3 m away from the electrodes to provide a representation of the effect of the electrode at varying distances from the electrodes.

GPS readings were recorded at all sampling locations, or an equivalent technique to geo-reference the sampling locations.

As the drilling progressed at each sampling location, soil samples were collected every 0.3 m beginning with top soil.

Samples collected from the topsoil and at depths of electrode placement were analyzed for metals, salinity parameters, pH, and grain size.

Samples were retained for organic testing (heterotrophic microbes, organic matter) from the topsoil, at the point of electrode placement at all locations.

Three soil samples were retained for PHC analysis (highest vapours or water table).

Soil cuttings from monitoring wells were placed in soil bags. Composite samples of the soil cuttings were collected for testing for leachable benzene, toluene, ethylbenzene and xylenes (BTEX). Leachable metals, flashpoint, pH and paint filter tests were also conducted. Bentonite was placed at the base of the boreholes to above the water table and then the remainder was backfilled with cuttings.

### Well Installations:

Monitoring wells and soil test locations were placed based on EM/ERT baseline data.

Existing upgradient tests were used, installing 3 wells at electrodes as well as two downgradient wells. The depth to water table and depth to base of electrode is of minimal distance and therefore nested wells were not appropriate.

An Auger rig was suitable for well installations based on historic soil logs.

### Bench Scale Testing

2 m³ of soil required for bench scale tests was collected and utilized for the tests. The tests determined if electro-kinetics was effective in reducing salinity concentrations in soils or if salinity cations/anions could move under an applied electrical field.

Soil was sampled prior to shipping and tested for salinity parameters including chlorine, pH heterotrophic bacteria count, metals and grain size.

The bench scale tests consisted of applying different voltages and amperages using a step approach to determine the rate of movement in the soil. Amperage is the controlling factor since as long as you carry a current, there is contaminant migration. The processes involved in the design were adjusted as needed to determine the best efficiency. The length (time) of each process is important to maintain the electrical field. The soil conditions and contaminant concentration were also used to test the effectiveness of the electrode design. At the end of the bench scale soil samples were taken from different areas of the test soils and at different depths. Soils were tested for pH, salinity and metal parameters, in addition to microbial activity. Water extracted from the electrodes was also tested for routine water parameters and dissolved metals. Soils in the shipping container were also tested for hydrogen sulphide (“H2S”) and chloride gas using detectors.

### Baseline Groundwater Monitoring and Sampling

Each groundwater well was monitored for liquid levels using an interface probe and combustible vapours using a gasdetector, purged and sampled for dissolved metal and routine parameters. Routine water parameters include: calcium, sodium, chlorine, pH, EC, total dissolved soils, magnesium, etc, Submit select samples for both metals, vinyl chloride and a tri-halo methane scan.

A relative vertical survey of the top of the well casings and ground beside the wells was conducted.

Groundwater samples were collected and appropriately preserved and stored. Samples that were submitted for metal analyses were field filtered prior to adding appropriate preservatives Samples were then submitted for testing.

### System Installation and Operation

Electro-kinetics system with zero ground disturbance (equipment should cause no compaction or rutting of soils onsite) was installed.

Grounding rods were installed near the electrodes.

Three sets of electrodes were installed. Each electrode set consisted of a positive and negative charged electrode pair installed below the ground surface Electrodes were placed at the top and bottom of encountered salinity contamination.

Electrodes were horizontally drilled and were installed greater than 10 m from all pipelines or electrical lines. The locations of electrodes were recorded using GPS. Phase I power and a phase converter (to obtain 3-phase power) were needed to provide the required power to the remediation equipment.

During the operation the vadose zone (unsaturated soil zone) was flushed to keep the top electrode wet.

Extracted water was treated with electrodialysis. Part of the treated water was used for flushing water for the vadose zone and part was deep well injected due to water hardness.

Weekly maintenance and pH checks were performed.

The system was operated for approximately 2 months.

### Groundwater Monitor and Sample During System Operation (Conducted Every 2 Weeks After the Start of the System Operation)

Liquid levels and combustible vapour readings were monitored in each groundwater well.

Groundwater wells were purged prior to sampling.

Groundwater at wells was tested for the following parameters: dissolved metals (sampled water filtered in the field using naglene filters), and routine water parameters (include salinity and pH parameters), and other site-specific parameters/concentrations as appropriate.

### Groundwater Monitor and Sample (Post Operation—Approximately 1 Week Following Shut-Down)/Post Soil Test/Post EM/ERT (All Following Equipment Shut Down)

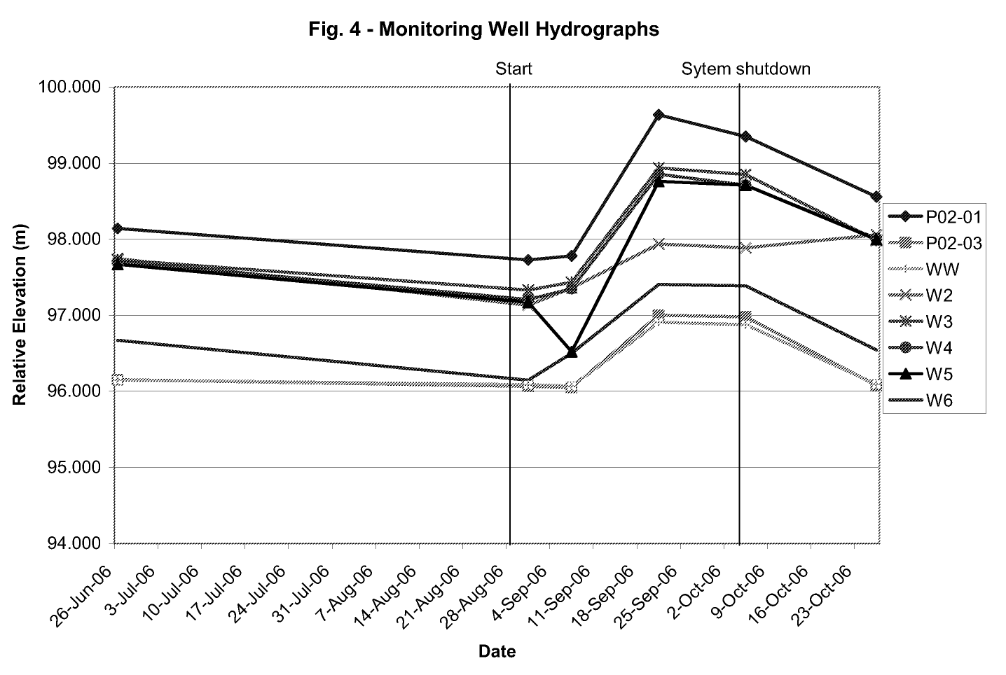

Liquid levels and combustible vapour readings were monitored. The results of the groundwater elevations changes are shown in FIG. 4. Groundwater elevations changes in the remediation area (top trend lines) had similar trends to groundwater elevations changes in the background well (bottom trend line). Therefore, the remediation system had little or not effect on changes to groundwater elevations.

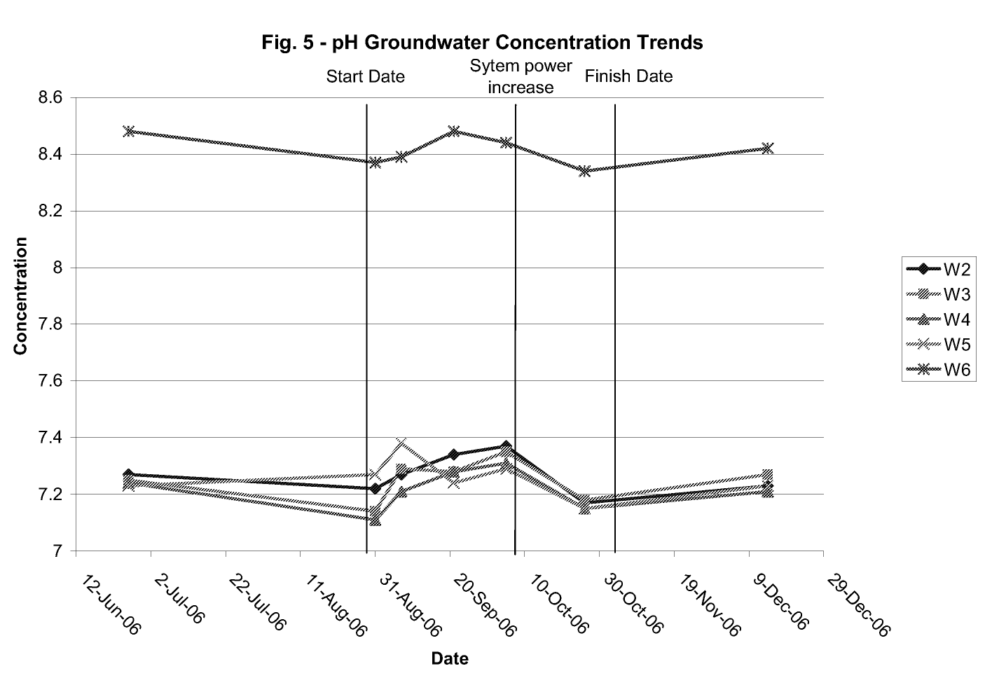

Groundwater at wells was tested for the following parameters: dissolved metals electrical conductivity, and routine parameters. Some of the results are shown in FIG. 5, 6A to D, 7, and 8. The majority of the dissolved metals parameters measured in the groundwater samples indicated that the Electrokinetics system operation increased or decreased dissolved metal concentrations as follows:
Increase due to system (dissolution from soils): As, Li, Se;
Decrease due to system: Ba, Mn, S (spike on Oct. 5, 2006); and
Not affected by system: Cd, Cr.

FIG. 5 is a graph showing groundwater pH is not affected by electro-kinetic remediation as pH in groundwater collected from remediation area had similar trends as background wells.

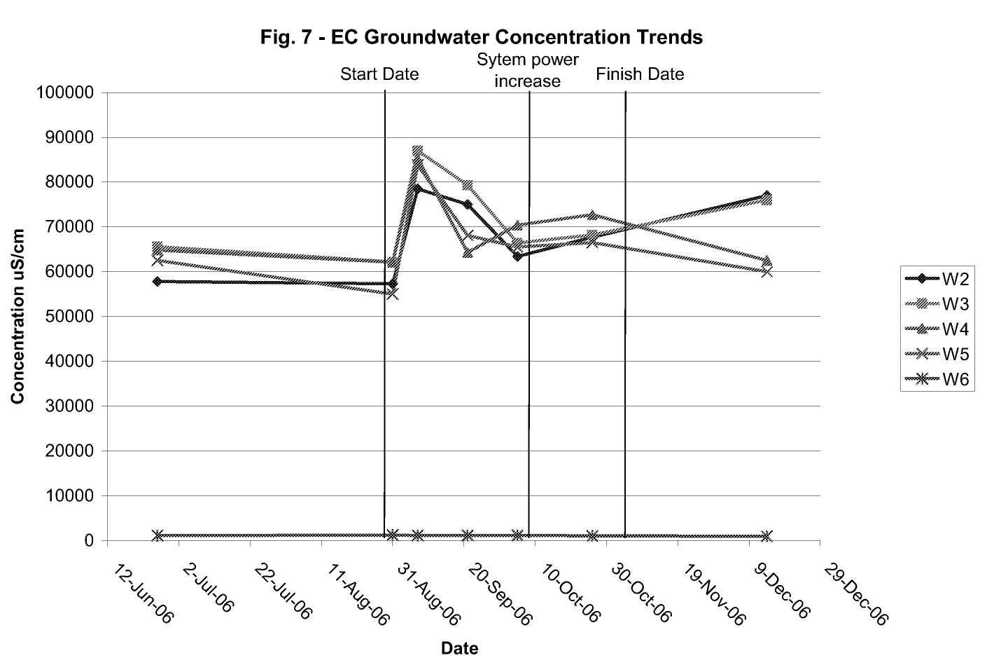

FIG. 7 is a graph showing decreasing levels of EC in the groundwater during the operation of the Electrokinetics system.

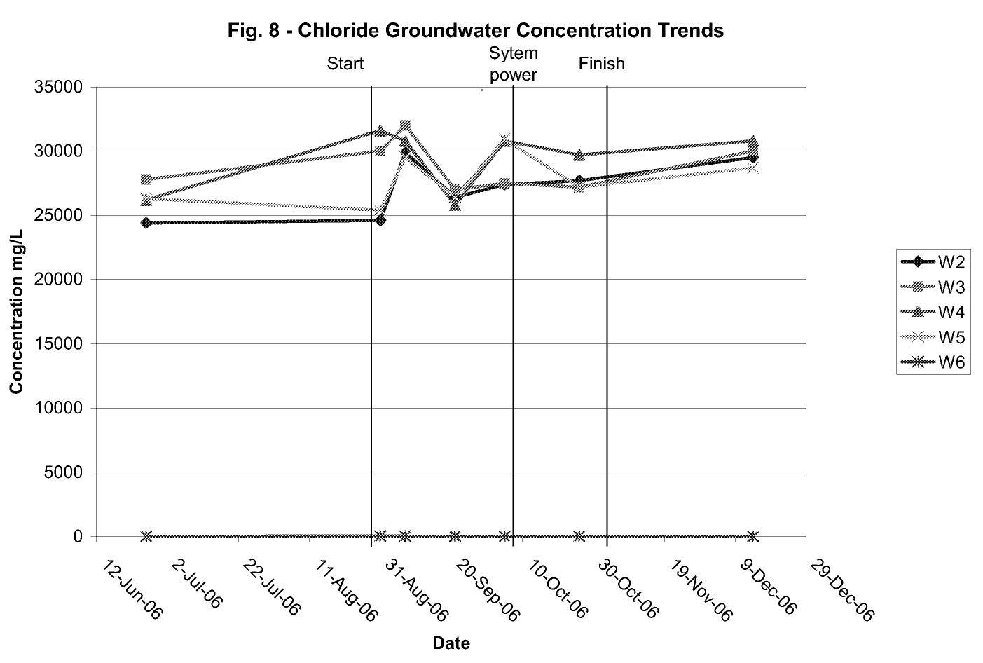

FIG. 8. is a graph showing dissolution of chlorides from soils to groundwater after the Electrokinetics system started up and following an increase of the system voltage.

Other site-specific parameters/concentrations were measured as appropriate (i.e. vinyl chloride and tri-halo methane). These parameters were not detected in groundwater samples collected from the remediation area during the operation of the Electrokinetics system.

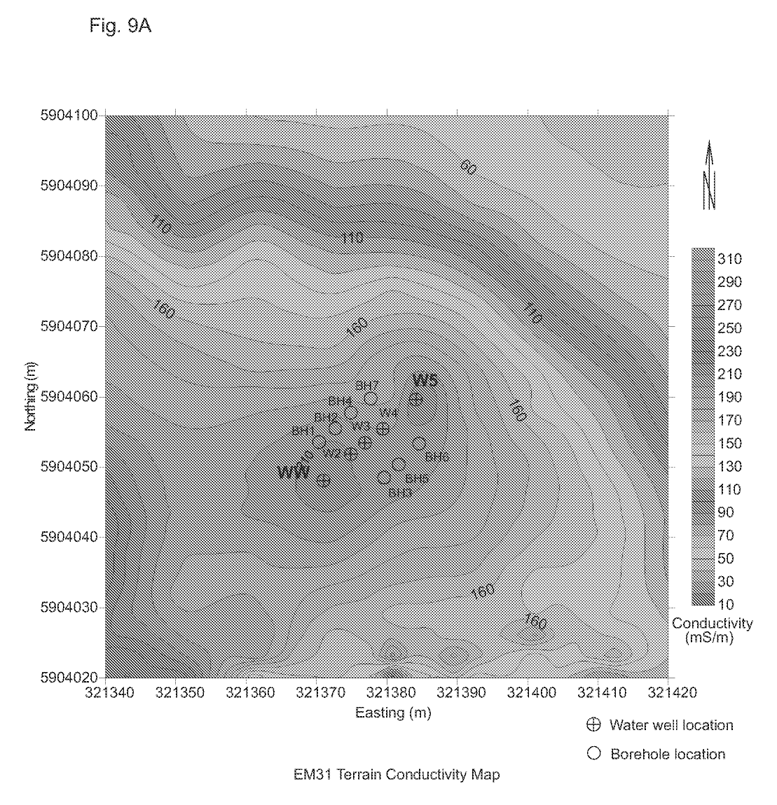

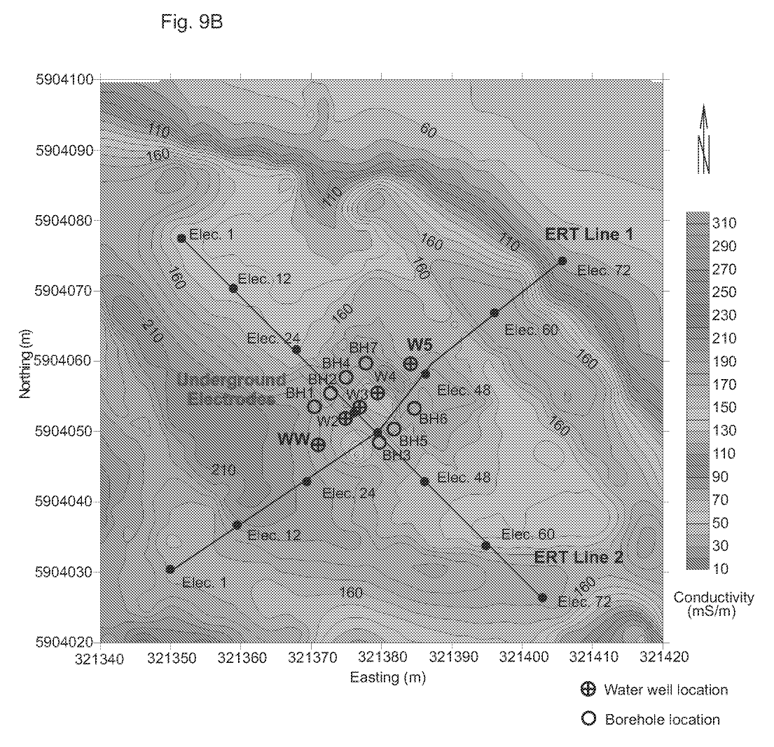

EM and ERT scans were conducted both prior to and following electro-kinetic remediation. A post-electro-kinetic remediation EM scan was conducted to establish a visual picture of the progress made in reducing salinity in the subsurface. The results are shown in FIGS. 9A (prior to electro-kinetic remediation) and 9B (following electro-kinetic remediation).

FIG. 9A is an EM scan of the contaminated site prior to the electro-kinetic remediation.

FIG. 9B is an EM scan of the contaminated site after the electro-kinetic remediation. The post electro-kinetic remediation scan shows that the conductivity of the contaminated area has decreased in the area of the electrokinetics system was applied.

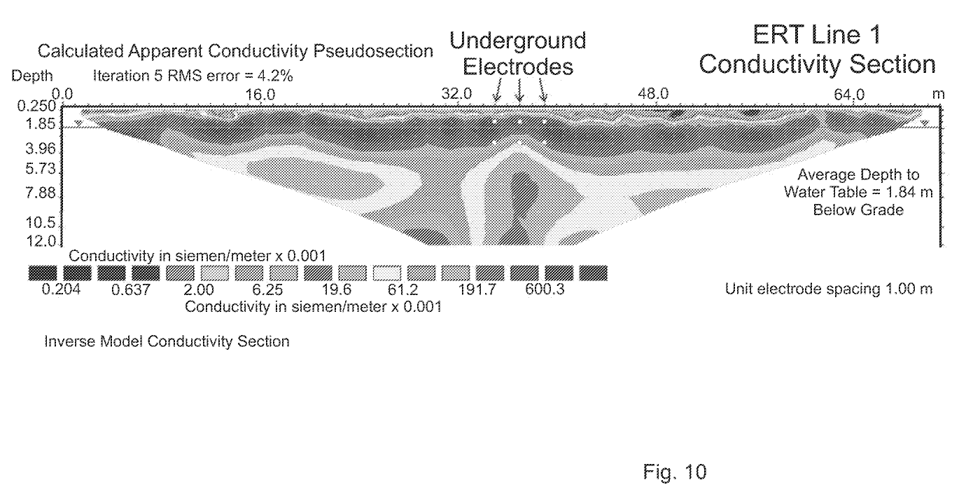

An ERT survey was also conducted following electro-kinetic remediation. The resulting survey is shown in FIG. 10.

FIG. 10 is an ERT survey of the contaminated site indicating lower conductivity in the vicinity of electrodes.

Soil sampling was conducted and tested for metal, salinity, pH and microbes immediately adjacent to locations tested during baseline testing. The same soil sample depths were selected as the baseline soil testing (Data not shown). GPS recordings were taken at all sampling locations. Soil results indicated that metals concentrations, microbe populations and pH in soils had negligible changes when comparing pre-remediation and post-remediation soil samples Anions migrated towards the positive negative electrodes and cations migrated towards the negative electrodes as expected. Chloride ions did not decrease as much as expected at the positive electrode, but chloride ions are expected to decrease with longer operation of the Electrokinetics system.

### Haul Effluent Water for Treatment by Electrodialysis or Treat Onsite

Effluent water was tested for routine and metal parameters. The results are pH. 2.95 (effluent) vs 7.1 to 8.5 (gw wells), ∘EC up to 15,000 uS/cm, ∘Hardness up to 25,000 mg/L, ∘Chloride up to 5,000 mg/L, ∘TDS up to 35,000 ppm (sea water)

Effluent water requiring hardness reduction prior to processing with electodialysis was reduced.

The data obtained was analysed and further remediation was conducted to optimize the remediation.

One of ordinary skill in the art would recognize other variations, modifications and alternatives. It should be recognized that while the present invention has been described in the preferred embodiments thereof, those skilled in the art may develop wide variation of structural and operational details without departing from the principles of the invention. Therefore, the appended claims are to be construed to cover all equivalents following within the true scope of the spirit of the invention.

I claim:

1. A process for assessing and remediating a contaminated site comprising the steps of:
assessing contaminated soil and/or groundwater at a contaminated site by conducting geophysical scans of the site;
assessing the contaminated soil and/or groundwater by analyzing the soil and water samples for chemical parameters;
remediating the soil and/or groundwater by electro-kinetics;
during remediation, assessing the contaminated site by conducting hydrological and chemical tests of the water; and
assessing the remediated soil and/or groundwater by conducting electromagnetic scans of the site.

2. The process for assessing and remediating a contaminated site in claim 1 which further includes the step of assessing contaminated soil and water by conducting salinity, pH, and metal tests of the soil and water before remediation.

3. A The process for assessing and remediating a contaminated site in claim 1 which further includes the step of assessing contaminated soil by conducting microbial tests before remediation

4. The process for assessing and remediating a contaminated site in claim 1 which further includes the step of remediating effluent water by electrodialysis

5. The process for assessing and remediating a contaminated site in claim 4 which further includes the step of reusing the remediated water during electro-kinetic remediation or reinjecting the remediated water into a groundwater zone the remediated water was previously extracted from.

6. The process for assessing and remediating a contaminated site in claim 1 which further includes the step of conducting chemical, pH, salinity and metal tests of the soil and water following remediation.

7. The process for assessing and remediating a contaminated site in claim 1 which further includes the step of conducting microbial tests of the soil following remediation.

8. The process for assessing and remediating a contaminated site according to any one of claims 1 to 7 wherein the contaminated site is contaminated with elevated salinity.
